(19) United States
(12) Patent Application Publication
(10) Pub. No.: US 2019/0295432 A1
(43) Pub. Date: Sep. 26, 2019

(54) PORTABLE, MODULAR, AIR TRAFFIC CONTROL SIMULATOR

(71) Applicant: Adacel Systems, Inc., Orlando, FL (US)

(72) Inventors: Michael Joseph Brady, Orlando, FL (US); Kevin Neil Pickett, West Melbourne, FL (US)

(73) Assignee: Adacel Systems, Inc., Orlando, FL (US)

(21) Appl. No.: 16/359,287

(22) Filed: Mar. 20, 2019

Related U.S. Application Data
(60) Provisional application No. 62/645,256, filed on Mar. 20, 2018.

(51) Int. Cl. G09B 9/00; G08G 5/00

(52) U.S. Cl. CPC G09B 9/006; G08G 5/0043; G08G 5/0013

(57) ABSTRACT

An air traffic control (ATC) simulator includes a plurality of rolling carts each supporting at least one visual display thereabove. The rolling carts are configured to store the visual displays therein for storage and transport. The carts also include computer hardware configured with software to drive the visual displays to display a panoramic view of an airport across the visual displays. The ATC simulator can be stored within two or more rolling carts for transport to and from any desired location. Once in a desired location, the visual displays are removed from the carts and set up thereabove. Data connections are made between each of the carts, power is supplied to the carts, and the ATC simulator is ready for use.

### CROSS-REFERENCE TO RELATED APPLICATION

This application claims the benefit of U.S. Provisional Patent Application Ser. No. 62/645,256, filed on Mar. 20, 2018, the contents of which are herein incorporated by reference in their entirety.

### FIELD OF THE INVENTION

The present invention relates to electronic simulators, and more particularly, to simulators configured for training and analyzing air traffic controllers.

### BACKGROUND OF THE INVENTION

A significant factor underlying the safety of modern air travel is the maintenance of a large body of highly proficient air traffic controllers throughout the world. An important and useful tool in the training and testing of air traffic controllers is the air traffic control (ATC) simulator. An effective ATC simulator should present users with a realistic facsimile of control tower operations, including air and ground communications, radar and other operator consoles and controls, as well as the visual picture of the surrounding airport. Moreover, for most effective training and analysis of controllers in the field, the ATC simulator should present this realistic facsimile of the airport where the controllers are stationed.

While there are very effective immersive ATC simulators available, such simulators typically place significant demands on the host facility. For example, the simulator usually requires at least one dedicated room to mount the simulator consoles, monitors and supporting computer equipment. The power supply arrangement to the room will often require upgrading. Costs for installation and on-site maintenance, as well as the inherent cost of permanently removing one or more good-sized rooms from general use, can be considerable. As a result, implementing such ATC simulators at or near the majority of controlled airports is impractical.

### SUMMARY OF THE INVENTION

In view of the foregoing, it is an object of the present invention to provide a portable, modular air traffic control (ATC) simulator. According to an embodiment of the present invention, an ATC simulator includes a plurality of rolling carts each supporting at least one visual display thereabove. The rolling carts are configured to store the visual displays therein for storage and transport. The carts also include computer hardware configured with software to drive the visual displays to display a panoramic view of an airport across the visual displays. Accordingly, the ATC simulator can be stored within two or more rolling carts for transport to and from any desired location. Once in a desired location, the visual displays are removed from the carts and set up thereabove. Data connections are made between each of the carts, power is supplied to the carts, and the ATC simulator is ready for use.

These and other objects, aspects and advantages of the present invention will be better appreciated in view of the drawings and following detailed description of preferred embodiments.

### BRIEF DESCRIPTION OF THE DRAWINGS

FIG. 1 is a perspective view of an air traffic control (ATC) simulator, according to an embodiment of the present invention, including a plurality of rolling carts and equipment mounted thereon;

FIG. 2 is a perspective view a representative one of the rolling carts of FIG. 1, with equipment stored therein and side panels removed to show interior details;

FIG. 3 is a perspective view of a differently configured rolling cart usable in connection with the ATC simulator of FIG. 1;

FIG. 4 is a schematic diagram of electrical and data connections of the ATC simulator of FIG. 1;

FIG. 5 is a schematic diagram of the ATC simulator of FIG. 1 additionally including one of the carts of FIG. 3;

FIG. 6 is a schematic diagram of the ATC simulator of FIG. 1 additionally including two of the carts of FIG. 3; and

FIG. 7 is a perspective view of another differently configured rolling cart usable in connection with the ATC simulator of FIG. 1.

### DETAILED DESCRIPTION OF PREFERRED EMBODIMENTS

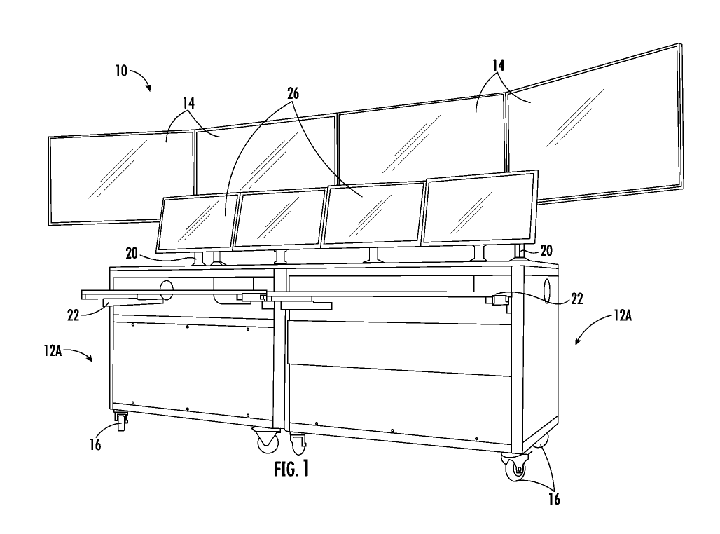

According to an embodiment of the present invention, referring to FIG. 1, an air traffic control (ATC) simulator 10 includes a plurality of rolling carts 12 each supporting at least one visual display 14 thereabove. The rolling carts 12 are configured to store the visual displays therein for storage and transport. The carts 12 also include computer hardware configured with software to drive the visual displays 14 to display a panoramic view of an airport across the visual displays 14. Accordingly, the ATC simulator 10 can be stored within two or more rolling carts 12 for transport to and from any desired location. Once in a desired location, the visual displays 14 are removed from the carts 12 and set up thereabove. Data connections are made between each of the carts 12, power is supplied to the carts, and the ATC simulator is ready for use.

Each of the rolling carts 12 features a cart body supported by plurality of wheels 16, preferably heavy-duty locking casters, permitting easy rolling of the carts 12 between uses. The exterior dimensions of each cart 12 are preferably identical, with a front-to-back depth selected to ensure the carts will fit through any standard commercial door (i.e., less than approximately 32 inches). As used herein, the “front” of a cart is the side toward which the visual displays 14 are generally oriented when mounted. The side-to-side width should be sufficient to accommodate the width of the visual displays 14 in the interior of the cart body (e.g., for a 42 inch display, greater than approximately 37 inches), and the height should place the top surfaces of the cart bodies 12 at or near a comfortable working countertop height (e.g., approximately 36 inches).

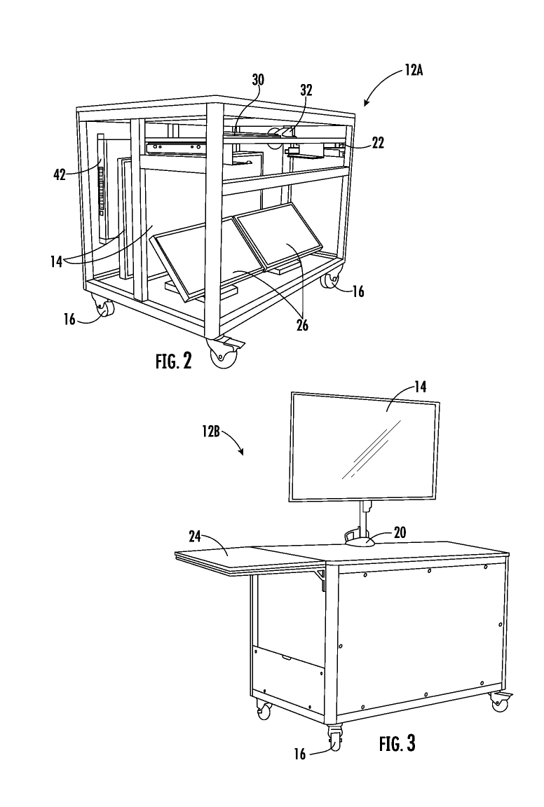

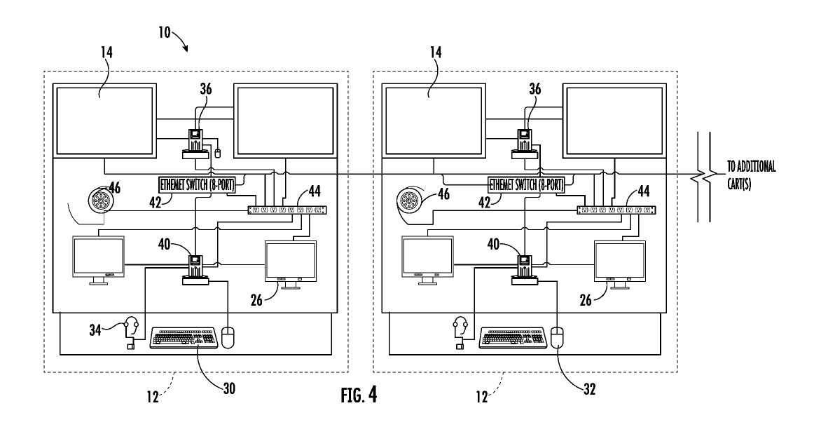

Referring also to FIGS. 2 and 3, the internal configurations of the carts 12 can vary. (The reference numeral 12 is used herein to refer generically to carts 12 of any configurations, while the Figures will utilize a reference numeral specific to the cart configuration, as appropriate.) Two advantageous configurations include a two display cart 12A, which affords a mounting attachment 20 to support two visual displays 14 side-by-side adjacent a rear edge thereof, and a single display cart 12B, which affords a mounting attachment 20 to support a single visual display 14 adjacent a rear edge thereof. Rather than, or in addition to, being attachable to and/or placed on top of the cart, mounting attachments could be free-standing. After use, such mounting attachment(s) would preferably be collapsible for storage within the cart. The cart 12A also includes an internal peripheral drawer 22 accessible from a front side thereof. The cart 12B includes one or more side desks 24 formed by folding up respective portions of one or more sides thereof.

In addition to the visual displays 14, each cart 12 advantageously includes one or more console displays 26. The console displays 26 are preferably smaller than the visual displays 14. Each console display 26 is stored inside a respective cart 12 when not in use, and placed on top of the cart 12 when the ATC simulator 10 is set up at a desired location. Referring also to FIG. 4, each cart 12 advantageously further includes additional peripherals for interaction with the console display(s) 26 and other simulation features, such a keyboard 30, mouse 32, and push-to-talk (PTT) headset 34. In the carts 12A, some or all of these peripherals can be stored on the peripheral drawer 22.

Each cart 12 includes a dedicated graphics driver module 36 for its respective visual display(s) 12, and a computer module 40 which drives the respective console display(s) 26 and connected peripherals. The graphics driver module 36 and computer module 40 both connect to a network switch 42, which is in turn connectable to network switches 42 of one or more adjacent cart(s) 12, as will be discussed in greater detail below. The visual display(s) 12, console display(s) 26, graphics driver module 36, computer module 40 and network switch 42 all plug in to a common power module 44, such as a power strip. The power module 44 is connectable to A/C power at a desired location of use via a retractable cable spool 46.

In use, one or more user(s) determines what ATC simulator 10 configuration is optimal for the training or testing to be conducted at a desired location. The appropriate number and type of carts 12 are then moved to that location. The visual displays 14 are removed from inside the carts 12 and connected to the mounting locations 20. Likewise, the console displays 26 are removed from the carts 12 and placed on top. Peripheral drawers 22 are opened and peripherals are placed as desired by the user(s). A connection is made between the network switches 22 of each adjacent cart 12, and the cable spool 46 of each cart 12 is connected to external (typically A/C) power. Generally, each cart 12 is preferably connected to its own A/C outlet. Where permissible/desired, one cart 12 could be connected to A/C power, an adjacent cart 12 is plugged into that cart 12, and so on.

Once connected to A/C power, each cart 12 is powered up. A supervisor or other individual overseeing the training or testing can select any cart 12 as a control station and pull up control functions on the console display(s) 26 thereof. The computer module 40 of the selected cart 12 will automatically detect the number and type of additional carts. This controlling computer module 40 then drives all of the connected visual displays 14 through their respective graphics driver modules 36 to display a panoramic view of an airport to be used in the simulation. The controlling computer module 40 is also able to designate functions to be executed by the other computer modules 40 and console displays 26 during the simulation. Preferably, the controlling computer module 40 (and/or one or more other modules 40) records all simulation data, including user inputs, allowing for later analysis and debriefing of user performance on the ATC simulator 10.

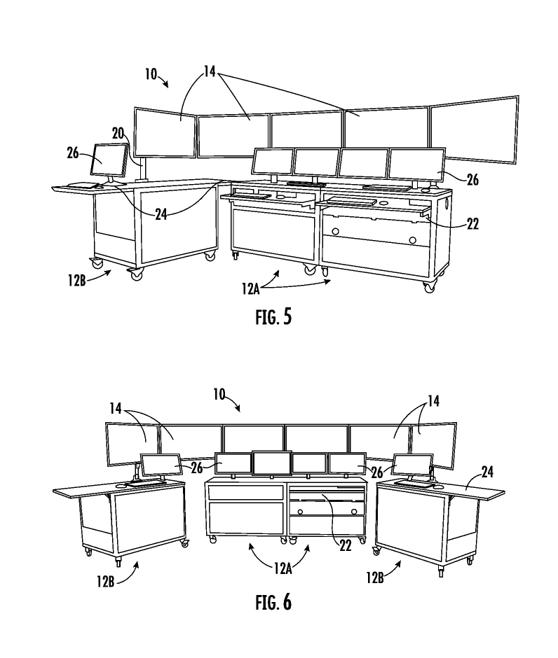

ATC simulators 10 of different sizes and operator/supervisor stations can be achieved simply by changing the number and type of carts 12 connected. For example, a more basic ATC simulator 10 can be achieved by simply connecting two carts 12A (as seen in FIG. 1). After the carts 12A are connected and powered up, a simulation is initiated at one of the carts 12A and then two operators proceed through the simulation working at respective carts 12A and viewing a panoramic display of the simulated airport on the four visual displays 14, collectively. For a more involved simulation one or two carts 12B are added beside the carts 12A, offering a five (FIG. 5) or six (FIG. 6) screen display and affording one or two additional operator positions.

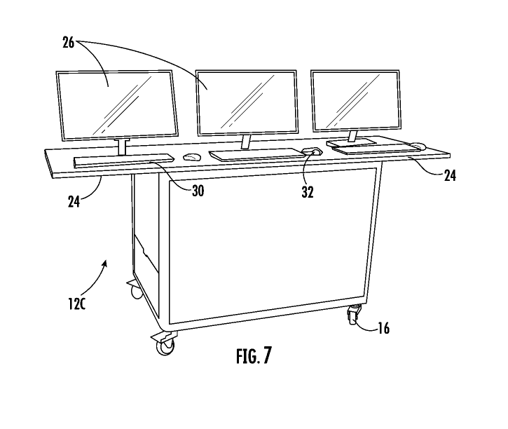

The additional operator positions could be used, for instance, as workstations for a participant acting as a pilot and/or an active position for a supervisor to monitor and/or alter the progress of the simulation. Besides additional carts 12 with visual displays 14, a cart 12C (see FIG. 7) having only console displays 26 (as well as other electronic components in support thereof) could be connected to provide additional operator positions.

The foregoing computer and display architecture, together with the portability of the carts 12, allows for extremely flexible use of the ATC simulator 10. Rather than having a permanent ATC simulator 10 proximate to every controlled airport, a number of carts 12 could be stored at a much smaller number of regional locations. Any required maintenance/updates to the carts 12 could also be performed at such locations (including simply swapping out any carts 12 requiring maintenance with other carts 12).

When an ATC simulator 10 is needed for training at a certain location with the corresponding region, a requisite number and type of carts 12 are loaded onto transport vehicles, moved to the location, unloaded and set up in a suitable space (which need not otherwise be devoted to that purpose). After training/testing is complete, the carts 12 are reloaded and transported back for storage or transported to the next location for use.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is Claimed is:

1. An air traffic control (ATC simulator comprising:
a first rolling cart including:
a first cart body supported by a first cart plurality of wheels, the first cart body having a first cart top surface and defining a first cart interior therebelow;
at least one first cart mounting attachment extending above the first cart top surface;
a first cart pair of visual displays connected to the at least one first cart mounting attachment above the first cart top surface, the first cart pair of visual displays being removable from the at least one first cart mounting attachment for storage in the first cart interior;
at least one first cart console display placed on the first cart top surface and removable therefrom for storage in the first cart interior with the first cart pair of visual displays, the at least one first cart console display being smaller than each of the first cart pair of visual displays;
a first cart graphics driver module arranged in the first cart interior and connected to the first cart pair of visual displays;
a first cart computer module arranged in the first cart interior and connected to the at least one first cart console display;
a first cart network switch arranged in the first cart interior in signal communication with the first cart graphics driver module and the first cart computer module; and
a first cart power module connected to the first cart pair of visual displays, the at least one first cart console display, the first cart graphics driver module, the first cart computer module and the first cart network switch, the first cart power module being connectable to external power; and
a second rolling cart including:
a second cart body supported by a second cart plurality of wheels, the second cart body having a second cart top surface and defining a second cart interior therebelow;
at least one second cart mounting attachment extending above the second cart top surface;
a second cart pair of visual displays connected to the at least one second cart mounting attachment above the second cart top surface, the second cart pair of visual displays being removable from the at least one second cart mounting attachment for storage in the second cart interior;
at least one second console display placed on the second cart top surface and removable therefrom for storage in the second cart interior with the second cart pair of visual displays, the at least one second cart console display being smaller than each of the second cart pair of visual displays;
a second cart graphics driver module arranged in the second cart interior and connected to the second cart pair of visual displays;
a second cart computer module arranged in the second cart interior and connected to the at least one second cart console display;
a second cart network switch arranged in the second cart interior in signal communication with the second cart graphics driver module and the second cart computer module; and
a second cart power module connected to the second cart pair of visual displays, the at least one second cart console display, the second cart graphics driver module, the second cart computer module and the second cart network switch, the second cart power module being connectable to external power;
wherein the first and second cart mounting attachments are arranged so that the first and second cart pairs of visual displays collectively form a panoramic display, the first and second cart network switches are in signal communication and both the first and second cart computer console are independently configured to drive the first and second cart pairs of visual displays using the first and second cart graphics drivers modules through the first and second cart network switches to display a simulated airport on the panoramic display.

2. The ATC simulator of claim 1, further comprising a third rolling cart including:
a third cart body supported by a third cart plurality of wheels, the third cart body having a third cart top surface and defining a third cart interior therebelow;
at least one third cart mounting attachment extending above the third cart top surface;
a third cart visual display connected to the at least one first cart mounting attachment above the first cart top surface, the third cart pair of visual display being removable from the at least one third cart mounting attachment for storage in the third cart interior;
at least one third cart console display placed on the third cart top surface and removable therefrom for storage in the third car interior with the third cart visual display, the at least one third cart console display being smaller than the third cart visual display;
a third cart graphics driver module arranged in the third cart interior and connected to the third cart visual display;
a third cart computer module arranged in the third cart interior and connected to the at least one third cart console display;
a third cart network switch arranged in the third cart interior in signal communication with the third cart graphics driver module and the third cart computer module; and
a third cart power module connected to the third cart visual display, the at least one third cart console display, the third cart graphics driver module, the third cart computer module and the third cart network switch, the third cart power module being connectable to external power;
wherein the third cart mounting attachment is arranged so that the third cart visual display collectively forms a panoramic display together with the first and second cart pairs of visual displays, the third cart network switch is in signal communication with the first and second cart network switches and all of the first, second and third cart computer consoles are independently configured to drive the first and second cart pairs of visual displays and the third cart visual display using the first, second and third cart graphics drivers modules through the first, second and third cart network switches to display a simulated airport on the panoramic display.

3. The ATC simulator of claim 2, wherein the third cart body further includes a side desk formed of a side thereof folded upwardly.

4. The ATC simulator of claim 1, further comprising a third rolling cart including:
a third cart body supported by a third cart plurality of wheels, the third cart body having a third cart top surface and defining a third cart interior therebelow;
at least one third cart console display placed on the third cart top surface and removable therefrom for storage in the third car interior with the third cart visual display;
a third cart computer module arranged in the third cart interior and connected to the at least one third cart console display;
a third cart network switch arranged in the third cart interior in signal communication with the third cart computer module; and
a third cart power module connected to the at least one third cart console display, the third cart computer module and the third cart network switch, the third cart power module being connectable to external power;
wherein the third cart is arranged adjacent to the first and second carts and the third cart network switch is in signal communication with the first and second cart network switches and the third cart computer console is also independently configured to drive the first and second cart pairs of visual displays using the first and second cart graphics drivers modules through the first, second and third cart network switches to display a simulated airport on the panoramic display.

5. The ATC simulator of claim 1, wherein a front-to-back depth of each of the first and second cart bodies is less than 32 inches.

6. The ATC simulator of claim 5, wherein a side-to-side width of each of the first and second cart bodies is sufficient to completely accommodate a width of the first and second cart pairs of visual displays in the first and second cart interiors, respectively.

7. The ATC simulator of claim 6, wherein every one of the first and second cart pairs of visual displays is at least a 42 inch display.

8. The ATC simulator of claim 1, wherein the first cart further includes a first cart peripheral drawer located immediately below the first cart top surface.

9. The ATC simulator of claim 8, further comprising at least one first cart peripheral stored in the first cart peripheral drawer and in signal communication with the first cart computer module.

10. The ATC simulator of claim 9, wherein the at least one first cart peripheral includes at least one of: a keyboard, a mouse, and a push-to-talk (PTT) headset.

11. The ATC simulator of claim 1, wherein the at least one first and second cart mounting attachments are connected to the first and second cart bodies, respectively.

12. A method of using an air traffic control (ATC) simulator, the method comprising:
transporting at least two rolling carts to a desired location;
removing a plurality of visual displays from interiors of the at least two rolling carts and mounting the plurality of visual displays above top surfaces thereof;
arranging the plurality of visual displays adjacently such that the plurality of visual displays collectively form a panoramic display;
removing at least one console display from the interior of at least one of the at least two rolling carts and placing the at least one console display on the top surface thereof;
connecting power modules of the at least two rolling carts to external power;
connecting respective network switches of the at least two rolling carts;
powering up electronic components of the at least two rolling carts, including the plurality of visual displays and at least one console display, from the power modules;
detecting a configuration of the ATC simulator from a controlling computer module in one of the at least two rolling carts; and
driving the plurality of visual displays from respective graphics drivers modules in the at least two rolling carts from the controlling computer module via the respective network switches in the at least two rolling carts to display a simulated airport on the panoramic display; and
running an ATC simulation utilizing the simulated airport.

13. The method of claim 12, wherein transporting the at least two rolling carts to a desired location includes loading the at least two rolling carts on a vehicle at an initial location and unloading the at least two rolling carts from the vehicle at the desired location.

14. The method of claim 13, further comprising:
after running the ATC simulation utilizing the simulated airport, shutting down the electronic components of the at least two rolling carts;
disconnecting the power modules from external power;
returning the plurality of visual displays and at least one console display to the interiors of the at least two rolling carts; and
transporting the at least two rolling carts from the desired location.

15. The method of claim 12, wherein removing the plurality of visual displays from the interiors of the at least two rolling carts and mounting the plurality of visual displays above top surfaces thereof includes removing a pair of visual displays from the interior of each of the at least two rolling carts and mounting each pair of visual displays above the top surface of a respective one of the at least two rolling carts.

16. The method of claim 12, wherein transporting at least two rolling carts to a desired location includes transporting at least three rolling carts to the desired location, the plurality of visual displays are removed from interiors of the at least three rolling carts and mounted above the top surfaces thereof, and the at least three rolling carts are arranged adjacently such that the plurality of visual displays collectively form a panoramic display.

17. The method of claim 12, wherein each of the at least two rolling carts includes a respective computer module and at least one respective at least one console display, and each of the respective at least one console displays are placed on the top surface of a respective one of the at least two rolling carts.

18. The method of claim 17, wherein detecting the configuration of the ATC simulator from the controlling computer module in one of the at least two rolling carts includes designating one of the respective computer modules as the controlling computer module.

19. The method of claim 18, further comprising using the controlling computer module to designate functions to be executed by the respective computer module not designated as the controlling computer module.

20. The method of claim 12, further comprising opening a peripheral drawer of at least one of the at least two rolling carts and arranging peripherals therefrom.

21. The method of claim 20, further comprising folding up a side desk from a side of at least one of the at least two rolling carts.

22. The method of claim 11, wherein removing the plurality of visual displays from the interiors of the at least two rolling carts and mounting the plurality of visual displays above top surfaces thereof includes connecting the plurality of visual displays to mounting attachments connected to the at least two rolling carts.
